(19) United States
(12) Patent Application Publication
(10) Pub. No.: US 2006/0151392 A1
(43) Pub. Date: Jul. 13, 2006

(54) Treatment of wastewater streams containing surfactants

(75) Inventors: Brian T. Mader, St. Paul, MN (US); Thomas J. Prausa, Minneapolis, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/329,809

(22) Filed: Jan. 10, 2006

Related U.S. Application Data
(60) Provisional application No. 60/642,874, filed on Jan. 11, 2005.

(51) Int. Cl. B01D 61/00

(52) U.S. Cl. 210/650

(57) ABSTRACT

A method of cleansing wastewater of surfactants. The method includes subjecting a wastewater stream containing surfactant contamination to ultra-filtration to separate components in wastewater including a concentrate and a permeate, and subjecting the permeate to contact with activated carbon sufficient to remove the surfactants to a desired level. The method is particularly suitable for dealing with surfactants from the alkylphenol ethoxylate family, and it is possible to reduce the level of surfactants in the wastewater stream to less than 0.1 mg/l by means of the disclosed method.

### CROSS-REFERENCE TO RELATED APPLICATION

This application claims the benefit of U.S. Provisional Patent Application No. 60/642,874, filed Jan. 11, 2005.

### TECHNICAL FIELD

The present invention relates to methods of treatment of wastewater streams, particularly those water streams containing surfactants, and more particularly those wastewater streams containing alkylphenol ethoxylates.

### BACKGROUND

Alkylphenol ethoxylates (APEs) are a category of surfactants commonly used in industrial processes. Octylphenol and nonylphenol ethoxylates are subclasses of the general category of APEs that are particularly useful in, for example, the preparation of emulsions industrially. However, for various reasons the discharge of APEs is being increasingly regulated, resulting in increasing pressure worldwide to reduce the discharge of these compounds to surface waters. The widespread use of APEs and increasing regulation of their discharge has many companies and municipalities searching to remove these compounds from their wastewaters.

It is known that APEs can be removed from aqueous solutions using granular activated carbon. However, activated carbon may not be effective for the primary treatment of wastewaters that contain these compounds. Often such wastewaters contain other compounds or phases in addition to the APEs that are competitive for adsorption onto the activated carbon or may foul the activated carbon. Should the concentration of these other compounds, or phases, be high enough, they could cause a decrease in the effectiveness of the removal of APEs onto the carbon. This is likely since APEs are often present in wastewater at part per million levels in wastewater from processes employing them, whereas other compounds competitive with the surfactants for the activated carbon may be present at percent levels. Under these conditions, relying on activated carbon for removing APEs is prohibitively expensive.

### SUMMARY OF THE INVENTION

In one aspect, the invention provides a method for removing surfactants from a wastewater stream, comprising the steps of subjecting the wastewater stream to ultra-filtration to separate phases, generating a concentrate and a permeate, and subject the permeate to contact with activated carbon sufficient to remove the surfactants to a desired level.

### BRIEF DESCRIPTION OF THE DRAWING

FIG. 1 illustrates a schematic view of an exemplary system or apparatus suitable for carrying out the method according to the present invention.

### DETAILED DESCRIPTION

In this application, “ultra-filtration” means a filtration media having pore sizes of from about 0.0025 to about 0.1 micrometers.

In general the present invention directed to methods of treatment of wastewater streams. In one aspect, the invention is directed to treatment all the water streams containing surfactants that can be present in multiple phases. What example of the surfactant that can be present multiple phases is chemicals belonging to the family including alkylphenol ethoxylates.

An advantage of exemplary embodiments of the present invention are that they provide a cost effective way of removing deleterious surfactants from wastewater. It has been discovered that while ultra-filtration is not capable of bringing surfactant levels down to sufficient levels, it can be used to extract enough of such compounds, as well as other compounds that compete with surfactants for adsorption to activated carbon, to allow activated carbon to be used economically for secondary treatment. The methods disclosed are particularly suitable for removing surfactants from the alkylphenol ethoxylate family from process wastewater, especially when multiple phases are present in the wastewater.

Depending on the composition of the other materials in the waste stream, the method of the present invention may permit the recycling of the concentrate back into the process that generated the wastewater. The method of the invention can be used to reduce the level of surfactants in the treated effluent to less than 0.1 mg/L. Other features and advantages will be apparent from the following description of the embodiments thereof, and from the claims.

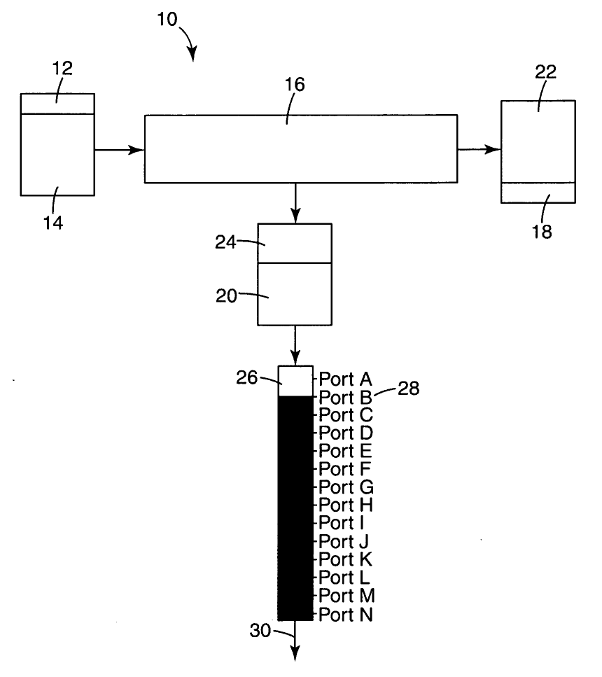

Referring now to FIG. 1, illustrated is a schematic representation of an exemplary wastewater treatment system or apparatus 10 suitable for practicing methods according to the present disclosure. The apparatus 10 includes a storage tank 12 for temporarily containing alkylphenol-contaminated wastewater 14. Wastewater 14 is pumped from a storage tank 12 into an ultra-filtration system 16. The ultra-filtration system 16 divides the wastewater 14 into a concentrate and a permeate. The output of the ultra-filtration system includes a filtered permeate 20 and a rejected concentrate 18. Illustrated apparatus 10 provides storage tanks 22 and 24 for temporarily holding rejected concentrate and filtered permeate 20, respectively.

Filtered permeate 20 is pumped from storage tank 24 into an activated carbon system 26. The activated carbon system 26 may have sample ports 28 so that the removal efficiency of the activated carbon system 26 can be monitored at intermediate points during the passage of filtered permeate 20. Treated effluent 30 emerges from the activated carbon system 26 for disposal.

Examples of commercially-available ultra-filtration systems include those available from GE-Osmonics, Vista, Calif., Koch Membrane Systems, Wilmington, Mass., and United States Filter Corp., Rockford, Ill. Examples of commercially-available activated carbon systems include those available from United States Filter, Ondeo Nalco Co., Naperville, Ill., and Calgon Carbon Corp., Pittsburgh, Pa.

### EXAMPLE

An apparatus generally as illustrated in FIG. 1 was constructed for the purpose of treating a wastewater stream containing cleaning oils and smaller amounts of surfactants, particularly a mixture of nonylphenol ethoxylates obtained under the tradename NPE Emulsifier Mix from Fuchs Lubricants Co., Harvey, Ill. An experimental run was performed with the apparatus to determine its suitability for removing surfactants from the wastewater stream. The experimental run consisted of four replicate runs with the results averaged.

A storage tank for the influent model wastewater was provided, having a capacity of 94 liters. The influent model wastewater consisted of approximately 5 mL of Silksol GB 2285 (Fuchs Lubricants Co.) per liter of city water. This solution had an average concentration of 1149 mg carbon/L, and with an average total nonylphenol ethoxylates concentration of 232 mg/L. This influent model wastewater was pumped into an ultra-filtration system (commercially available under the tradename “DEMOFILTER” having a 1 inch “ROMICON CM50” hollow fiber cartridge, commercially available from Koch Membrane Systems Co.) for separation. The ultra-filtration system separated the influent model wastewater into two streams: a rejected concentrate and a filtered permeate. The rejected concentrate was found to have an average oil concentration of 4352 mg carbon/L. The rejected concentrate also had an average total nonylphenol ethoxylates concentration of 1343 mg/L.

The filtered permeate had an average cleaning oil concentration of 36 mg carbon/L and an average total nonylphenol ethoxylates concentration of 33 mg/L.

The filtered permeate was stored temporarily in a storage tank having a capacity of 94 liters. The stored filtered permeate was pumped from the storage tank to the top of an activated carbon column using a model QD FMI pump (Fluid Metering Inc., Syosset, N.Y.), the filtered permeate was allowed to over-flow the column head to provide a constant column head pressure of about 0.91 psig. The column over-flow was sent back to the storage tank and recycled. The flow rate of filtered permeate through the column was nominally 60 mL/min.

The activated carbon system consisted of a clear PVC tube (McMaster Carr, Chicago, Ill.) having an inside diameter of 2.54 cm, a length of 40 cm, and was filled with 110 g of activated carbon available from Nalco. The activated carbon system had SWAGELOCK™ sample ports spaced about every 5 cm. The bottom of the column had a SWAGELOCK™ ball valve that was used to regulate the flow rate of permeate through the column. The column pressure was measured using a pressure meter (Noshok Inc., Berea, Ohio) located at the bottom of the column.

After passage through the activated carbon system, the resulting effluent had a total nonylphenol ethoxylates concentration of less than 0.1 mg/L. A total of 83 L of filtered permeate was treated.

Various modifications and alterations of the present invention will be apparent to those skilled in the art without departing from the scope and spirit of this invention, and it should be understood that this invention is not limited to the illustrative embodiments set forth herein.

1. A method for removing surfactants from a wastewater stream, the method comprising:
subjecting the wastewater stream to ultra-filtration to separate a concentrate from a permeate; and
subjecting the permeate to contact with activated carbon sufficient to remove the surfactants to a desired level.

2. The method according to claim 1 wherein the surfactants are alkylphenol ethoxylates.

3. The method according to claim 1 further comprising recycling at least a portion of the concentrate back into the process.

4. The method according to claim 1 wherein the desired level of removal of surfactants from the wastewater stream is less than 0.1 mg/L.

5. A system for treating wastewater containing alkylphenol ethoxylates, the system comprising:
a separation component for separating the wastewater into a concentrate and a permeate, wherein the output of the separation component includes a first stream including filtered permeate and a second stream including rejected concentrate, and further wherein the first stream is discharged from the separation component into a filtration device, wherein the filtration device comprises activated charcoal sufficient to remove the alkylphenol ethoxylates to a desired level.

6. The system of claim 5, wherein the filtration device includes at least one sampling port.
